(19) United States
(12) Patent Application Publication
(10) Pub. No.: US 2013/0191201 A1
(43) Pub. Date: Jul. 25, 2013

(54) COORDINATED NATURAL RESOURCE CONSERVATION

(71) Applicant: Leslie WEISE, III, Monument, CO (US)

(72) Inventor: Leslie WEISE, III, Monument, CO (US)

(21) Appl. No.: 13/732,174

(22) Filed: Dec. 31, 2012

Related U.S. Application Data
(60) Provisional application No. 61/590,945, filed on Jan. 26, 2012.
(60) Provisional application No. 61/590,018, filed on Jan. 24, 2012.

(51) Int. Cl. G06Q 10/00

(52) U.S. Cl. CPC G06Q 10/30; G06Q 30/0226
USPC 705/14.27

(57) ABSTRACT

The reuse of consumer materials, such as bags, cartons, containers and the like, or the participation in more sustainable activities, such as car pooling, are tracked in conjunction with a sponsoring entity, such as a commercial establishment where the materials are reused by an individual, and that reuse is tracked and credited as an economic value. The economic value is redeemable with a participant, such a merchant where the materials are reused, or another participant merchant, or a business or employer which sponsors such reuse. The economic value may be redeemed by an individual participant, or may be donated, sold, bartered or exchanged. Groups may participate in the reuse of materials, such as by joining together where the reuse of materials by any member of the group accumulates economic value for the group or a designee of the group, such as a charity.

### CROSS-REFERENCE TO RELATED APPLICATIONS

This application claims benefit of U.S. provisional patent application Ser. No. 61/581,945, filed Dec. 30, 2011, and U.S. provisional patent application Ser. No. 61/590,018, filed Jan. 24, 2012, which are herein incorporated by reference.

### BACKGROUND OF THE INVENTION

### Field of the Invention

The invention relates to the fields of natural resource conservation and efficiency, as it relates to consumer behavior and communications. These fields come together when social media, technology, and economic incentives can be used to manage the demands for natural resource consumption.

Most natural resources are non-renewable and are in finite supply. For example, resources that are mined such as fossil fuels, rare earth metals and other minerals do not renew themselves in a geologic timeframe that is practical for near term future reliable use by humans. And with renewable resources of air, water and timber, care must be taken that humans do not over pollute or overuse them such that interference with their ability to healthfully renew themselves occurs. Since the industrial revolution, humans have been depleting many of these resources in a non-sustainable manner for use in the consumer products and services we purchase and consume on a daily basis. Further, it is estimated that over 90% of the raw materials that comprise our consumer products are discarded within six months of their use, by various means of being burned, buried, discarded for placement in a waste disposal location, or otherwise go unattended and end up being scattered and distributed in the land or in oceans or other water bodies, all having long term deleterious effects on the environment. While worldwide population and consumption rates continue to rise, our current consumption rate of the available natural resource supplies is not sustainable into the future based on an increasing forecast for their use in consumer products and services. Such non-sustainable practices negatively affect the health of the environment and individual ecosystems that depend on our natural resources; human health and social costs are also adversely impacted.

While consumer rewards and loyalty programs are well known, they exist mainly for rewarding consumers for increasing levels of purchases, i.e. the more you buy, the more you earn. What is presented by Applicant is a type of loyalty program for rewarding people who use fewer natural resources to conduct the commercial transactions and social activities in their daily lives.

### SUMMARY OF THE INVENTION

The present invention is an Economic Value Generation system and method (EVG) that effectively uses Reusable Products (RP), communications, educational, computer processing and tailored software applications, behavioral modification techniques and social media to enable a valuable economic resource to be created from the collective actions of individuals and groups of individuals regarding their use and reuse of RPs.

The present invention provide a business method and system for increasing consumer awareness and participation in the reduction of natural resource consumption, by providing products that are designed for reuse (“Reusable Products” or “RP”), and providing incentives to consumers for their use and reuse of these Reusable Products in lieu of the products they replace that were designed for single use. A method and system for tracking the RPs and the use and reuse of RPs, generating an economic value (EV) related to their use and reuse in commerce, accessing information related to RPs and EV, and redeeming or exchanging that economic value (EV) is provided, and in combination with economic incentives and other features that serve to engage people through communications and social networking applications, creates an effective means for decreasing rates of natural resource consumption. Applicants' invention enables the empowerment and education of consumers to have more control over their consumption of natural resources, by providing the tools with potential to create a marketable and valuable resource as a motivation and reward for consumers' efforts and actions of conservation, reuse and recycling of products and the raw materials that comprise those products. The EVG 20 system and method is also applicable to products intended for single use that may be reused, as well as alternate activities that use fewer natural resources than their more traditional counterpart activities (“RP”).

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic illustration of the Economic Value Generation system and method for economic value generation through coordinated natural resource conservation.

### DETAILED DESCRIPTION

The core of the EVG 20 system and method described herein is an integrated consumer product and communications framework that provides tools and information to consumers, commercial entities and other organizations to motivate and incentivize a reduction in natural resource consumption by one or more consumers. Behavioral modification techniques are incorporated in the communications framework to maximize effectiveness. The novel approach presented by the EVG 20 is the unique combination of using reusable consumer products or products having reusable components, and targeted behavioral modification and educational techniques, with communications, software and social media tools to produce resources that have value to many entities. Such entities and the economic value created for them include commercial entities desiring a lesser need and expense for use of certain products and raw materials in the products and services they sell, municipalities or other entities who desire to reduce expense and their need to process waste, and individuals, groups and society in general desiring a reduced impact to the environment for the raw materials from natural resources that comprise consumer products, reduced waste, and lower associated social costs for related adverse health and pollution issues and related infrastructure needs resulting from a lack of reuse and recycling of materials.

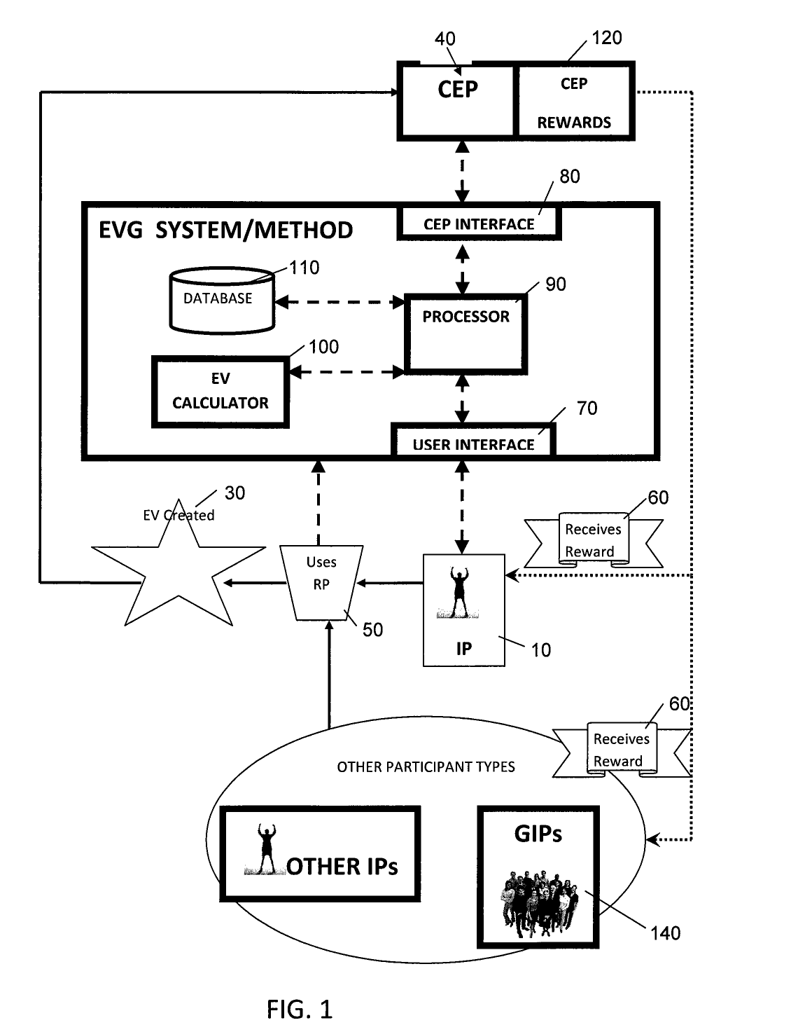

FIG. 1 shows the framework for the use and operation of the EVG 20 system and method.

Referring to FIG. 1, there is shown a flow chart for the reuse of a consumer material. In this example, an individual participant 10 who wishes to participate in a reuse program interacts with individual commercial entity participants 40, such as the act of buying groceries. The CEP 40 tracks, through an EGV System 20, the act of reuse corresponding to the individual participant 10 at the CEP 40, for example, the reuse of bags (a reusable product reuse 50) in which to carry the groceries away from the CEP 40. The tracked reuse activity generates economic value, or EV 30, which the individual participant 10 may redeem as an award 60.

The EGV system generally includes a user interface 70, into which a user may input their personal or other information in order to create an account in the EGV 20 which may accumulate EV 30, and through which the IP 10 may track their accumulated EV 30 and redeem rewards 60. The EGV 20 also includes a CEP 40 interface 80, through which a CEP 40 accesses the EGV 20 and may inputs acts of reuse by an IP 10, as well as registers as a CEP 40 and set values such as point levels at which acts of reuse are values at that CEP 40. A reusable product (RP) will preferably include a tracking device, such as a bar code, etc., with which acts of reuse may be readily tracked, and the CEP 40 may scan the reusable product identifier which information is transmitted through a protocol such as an internet protocol through the CEP 40 Interface 80 an to a processor from which an EV 30 may be calculated in an EV 30 calculator 100 and that value, and the act of reuse, are stored in a database 110. When an IP 10 wishes to redeem the EV 30 as a reward, the IP 10 may, through the user interface, determine their current total EV 30, and, through a CEP 40, select a CEP 40 reward 120.

Additionally, group IP's 10 (GIP) 140 may be established, and the act of reuse of any participant in the GIP tracked as a reuse of the GIP, such that the EV 30 of the GIP is tracked in the EGV System. As with the IP 10, the GIP may then receive a reward 60 from a CEP 40 based upon the value of the GIP 140 EV 30.

### IPs

An individual participant (IP) 10 of the EVG 20 may choose to take a proactive action to reuse a product (RP) when engaging in a commercial transaction, rather than relying on the product for only a single use, or a product with similar function whose design was intended for single use. An economic value (EV) 30 is generated when such use of the RP in commerce takes place. The EV 30 may be generated in a cumulatively linear manner in direct proportion to the frequency of use and reuse of RP, or in a non-linear increasingly scaled manner (not directly proportional), for each time the use or reuse of an RP at a commercial entity participant CEP 40 takes place. The EV 30 may then be used in commerce through redemption or full or partial exchange for products or services, for donation, for currency, or for discounts on products or services at commercial entities that participate in the EVG 20. Alternatively, the EV 30 may be donated or designated to people or entities other than the IP 10 or may be integrated with third party value systems. An individual participant may also be a commercial or non-commercial entity, such as, for example, a commercial entity that recycles wood pallets.

Groups of individuals may form through the EVG 20 system and may combine the EV 30 resources generated to benefit an IP 10, the group or other entity that is designated. Such a group may have an affiliation of some sort, e.g. as loosely connected as living in the same community or municipality, attending the same school, or belonging to the same membership such as AARP or a local YMCA, to a more organized connection of a sports team, political or religious organization or other more specific membership such as a local theatre group.

Individual participants (IP)s 10 and groups of individual participants (GIP)s 140—are collectively referred to herein as IPs 10.

### RP

The reusable product (RP) that may be used in the present invention may be any product, of which part or all of can be made for reuse as an RP rather than single use product, and that may be used by an IP 10 or GIP 140 in commerce as an alternative to using a similar function product from a commercial entity participant (CEP) 40 that has been designed for single use (such single use product herein referred to as SP). In effect, the need for single use products is decreased by the IP's 10 acts of using the RP or reuse of an RP. By way of example, such RPs may include bags for transporting consumer goods to and from a commercial facility or event, beverage cups, mugs, bottles, plates, utensils, cups and other containers for transporting beverages, food and other items purchased from or distributed by a restaurant, coffee shop, tea house, store, warehouse, retail establishment, wholesale establishment or other commercial entity, facility or event. The EVG 20 system and method also has applicability at events whose event planners, organizers or managers are currently, or have plans to, distribute, use or sell consumer products at one or more events. At such events, RPs may be used as an alternative to the supply of products designed for single use to attendees.

Reuse of an RP also includes acts of recycling some or all of the raw materials in the RP, repair of an item for further use in lieu of otherwise disposing of and replacing the item with a new or replacement item, or such other act that extends the use of the item or some or all of the natural resources comprising the item, as opposed to the disposal or replacement of an item or components of the item that might otherwise be designed for single or temporary use such that disposal or replacement of the item is avoided or the need for such disposal or replacement is prolonged, and the use of natural resources is thereby decreased; such acts are collectively referred to herein as “reuse of an RP” or “act of RP reuse” or “RP reuse act” or some other related form of these terms. RP may also include an act or transaction taken that is relatively more sustainable than an alternate act or transaction, or uses fewer natural resources than an alternate act or transaction, for example when two or more people carpool rather than each individual driving their own car to the same or nearby location, whereby less automobile fuel is consumed and fewer vehicle resources are required for the carpoolers.

### Commercial Entity Participant (CEP)

Commercial entity participants in the EVG 20 (CEP) 40 are those people, organizations and businesses that sponsor the EVG 20 in some way, including offering products and services to IP 10s 10 and accepting EV 30 toward the purchase of those offerings or the exchange of EV 30 for some other consideration. CEPs 40 also includes event planners, organizers or managers involved in the decision making process of what consumer products to distribute or sell at an event. CEPs 40 are those entities or people who participate in the EVG 20 system and method as a retail, wholesale or event organizing entity that sells, distributes or otherwise provides products, of which part or all of the RP can be made for reuse rather than single use. A CEP 40 may be in the business of selling goods or services, or may be a participant in the offering or distribution of goods or services in some form such as at events or through promotion of theirs or another's organization. A CEP 40 may instead or in addition participate in the EVG 20 system and method by accepting EVs for redemption or exchange for products and services or discounts on products and services offered in commerce. Alternatively, CEPs 40 may accept EV 30 in exchange for providing currency or other form of consideration to the EV 30 holder, or may simply participate in the EVG 20 as a sponsor, advertiser, or other supporting function wherein economic value is created through their participation that may be added to the EVG 20. An IP 10 may exchange their EV 30 at the same CEP 40 where the IP 10 used or reused an RP, or may exchange their EV 30 at a different CEP 40.

The EVG 20 system and method provides a forum for tracking, monitoring, participating in, and managing the activities relating to providing RPs, reuse of RPs, the redemption and/or exchange of EV 30, participation in the economic value generation, and for a CEP 40 to provide products or services for sale for which the EV 30 may be redeemed or exchanged or to provide discounts or other forms of consideration, and for IPs 10 to access such EVG 20 commerce. The forum may be accessed through and from a variety of networking and communication products and technologies, including stationary, mobile networking and internet accessing computers and devices. The forum may take the form of a more comprehensive website portal where users can access individual or group accounts and a wider range of features of the EVG 20 system and method, and aspects of this broader forum may also be accessible through more specific features and applications through third party social networking and other sites and membership; where for example, one or more of the following functions can take place: EV 30 can be tracked, redeemed, exchanged, donated or managed, goals can be set, and/or competitions, events and games can be planned, organized, managed and reviewed.

### Identification of CEPs

CEPs 40 that are participating in the EVG 20 system and method may be located or identified by IPs 10 through a label, logo, directory or electronic or communications identifier on a store front, website, advertising, or other sites accessible by IPs 10. Web and social media applications facilitate such identification, and may effectively coordinate IPs 10 with CEPs 40 so that reuse of RPs is facilitated and promoted. Such CEP 40 identification can be organized by product or service category type, by location, or other relevant sorting means including simple alphabetical or numerical listing. By way of example, an IP 10 may locate the most convenient CEP 40 for reuse of an RP or redeeming their EV 30 through a website portal on a computer, or through an application designed for this purpose through a hand held smart phone or other portable communication device. The communications information may be capable of identifying the IP 10 and the specific information about the IP 10 including their RP reuse acts and frequency, or may be more general and provide simple CEP 40 location or other general information. The communications information may also be capable of identifying the IP 10 and other information about the IP 10, RP or CEP 40, including the product or service purchases, acts and transactions, decisions regarding the associated choices, sales information and transactions associated with the RP or CEP 40, market data about shopping trends, consumer choices or social activities made or conducted while using the RP.

### Tracking

The tracking of RPs is accomplished by a tracking device which is preferably electronic and may be read and transmitted through electronic devices or a communications network and tracked and recorded through software associated with the electronics and/or communications, but may also be accomplished manually through record keeping means of recording frequency of acts of RP reuse by an IP 10 on lists accessed from computer accounts or other paper, notebook or other record keeping means, through punch cards, lists or other manual means. The RP use, reuse, repair and recycling frequency may be simultaneously or subsequently updated on the RP user account of the EVG 20 system and method. Preferably, tracking is accomplished via a bar code, QR code, RFID or other electronic or networking coding device or means located on the RP enabling tracking of the RP reuse frequency through electronic communication when the RP is used and reused as contemplated herein. Such device can be affixed in a more permanent form or semi-permanent replaceable manner on the RP, for example by printing the bar code or affixing a device within or on a fabric or plastic, metal or other material on the RP, or may be in a more temporary form such as a sticker, detachable piece such as Velcro or other snap, button, hook or other type of fastener. Alternatively or in conjunction with the tracking device located on the RP, tracking may occur through a tracking system in the possession of or in association with the IP 10 using the RP, or through a mobile electronic device such as a smart phone or portable computer device, or simply a key ring card or device or wallet smart card or other form of electronic or communications tracking that is portable and convenient for an IP 10 to access, that is capable of tracking the use and reuse frequency of the RP by an IP 10. Similarly, EV 30 redemption and status updates may be tracked manually or through other technological means existing in the art for tracking items and their use in commerce, either by the IP 10 or the CEP 40, or both which would ensure greater accuracy of record keeping. Further, tracking that is associated with the RP may occur including tracking information about the IP 10 and consumer transactions that occur, RP reuse acts and frequency, CEPs 40 frequented, general or specific product or service sales information associated with the IP 10, RP or CEP 40, market data about shopping trends or consumer choices made while using the RP. The tracking occurs when an IP 10 interacts with the EVG 20 at the CEP 40, either by scanning the pre-assigned coding device at an EVG 20 public interface, for example at a point of sale transaction location, scanning system, kiosk or electronic display, or otherwise identifying that the use of an RP occurred through some other agreed upon means, for example using his/her cell phone or other mobile device.

### EV Generator

An EV 30 generator using electronic data keeping software through computers and communications generally known in the art assigns an EV 30 for acts of RP reuse, recycling or repair of an IP 10. The EV 30 is generated based on frequency of RP reuse, and may be based on a linear or non-linear formula. The EV 30 is then available for use by the IP 10, GIP 140 or designee of the EV 30 for redemption toward, exchange for, or donation toward purchase of eligible consumer goods and services, currency or consideration, or alternatively for integration with another form of economic value by another entity. A compiler processes and one or more database keeps track of the EV 30 generated and the EV 30 redeemed, so that an IP 10 and CEP 40 may have real time or regularly updated access to an IP 10's EV 30 balance or status. The EVG 20 system monitors the EV 30 records for each IP 10 and CEP 40.

Economic value may also be generated through recycling the RP or those components of the RP that are recyclable for their raw material content and potential for reuse in new products. A recycle center may track the RP and designate credit toward the EV 30 for the IP's 10 acts of recycling such RP through the EVG 20 system and method. Such credit toward the EV 30 may be assigned to a different formula than the acts of reuse of the RP, and may be linear or non-linear in value. Alternatively, the recycling acts may be tracked by similar means as described above with regard to acts of reuse. EV 30 may also be tracked by accounting for the SP that are offset from their replacement in commerce by RP.

The economic value generated by the EVG 20 system and method may arise from various factors, including the economic savings by the CEP 40 through a reduced need for SP in commerce, through the economic or social advantages gained by the CEP 40 from a more loyal and increased customer base or through greater revenue or recognition through its participation in the EVG 20, and from the economic value created from recycling the raw materials of the RP or reduced amount of waste to process generated from single use products. Other economic value may be added through the community's social values of decreased waste streams and increased commercial and social participation in the community by IPs 10 and CEPs 40. For example, a municipality or community or commercial group may sponsor the EVG 20 system and method described herein based on the increased participation by its residents, members or consumers in activities that in effect improve the economic or social position of such entity. The value of the EV 30 is set through market dynamics based on what CEPs 40 assess are the social and/or economic benefits from the exchange, redemption or other recognition of such generated or perceived EV 30. The EV 30 value may be translated to U.S. or foreign currency, or may be translated to EVG 20 system currency. Still other value may be generated from the information collected through or in association with tracking the RPs about the IPs 10, RPs, CEPs 40 or generally about consumer data, including information about the IP 10 including their RP reuse acts and frequency, product or service purchased, other purchasing and demographic data and decisions concerning the IP 10, sales information and transactions associated with the RP or CEP 40, and/or market data about shopping trends or consumer choices made while using the RP.

The EV 30 generated may be redeemed for at least one of a) currency, b) discounts, c) exchanges toward products or services offered in commerce, or d) other forms of value that an IP 10 may recognize as having intrinsic economic value to them. The EV 30 may be redeemed or exchanged by an IP 10 or GIP 140 participant of the EVG 20, or may be donated to another person, group or organization designated by the IP 10 or by the EVG 20 system and method as instructed by or agreed to by the IP 10. The EV 30 may be integrated with other forms of value through other entities to generate an even greater aggregate economic or social value for use in commerce. The EV 30 may increase in a linear manner with each act of reuse of the RP, and it may increase in a non-linear manner with greater frequency of reuse of an RP to provide even greater motivation by an IP 10 to participate in the EVG 20 system and method and thereby reduce natural resource consumption. For example, the rewards generated by increasing acts of reuse of an RP may be significantly greater per each act of RP reuse than for a single or relatively lower frequency of RP reuse act. The EV 30 may have one or more of more random values associated with them, such as the IP 10 or account holder associated with the EV 30 being afforded the opportunity to participate in a lottery event, a special sale or rewards event, or limited special sales or rewards event if one of the first ten respondents or Xth respondent to the offer or until supplies of a particular reward or product for which discount or prize is being offered run out, or a reward based on the location or occasion an IP 10 is involved. Such EV 30 reward types can be announced to an IP 10 through many different ways, including through SMS text messages, emails, mail, courier or telephone, notice through social media applications available to an IP 10 and CEP 40, or through the website or notice by a CEP 40 or other participant to the EVG 20 system and method.

### Communications

The communications for such tracking of RP acts of reuse and redemption may be accomplished by a wireless mobile communication device or a stationary communication device, and transmitted through the internet or other networking means to one or more compilers for processing and storing in a database, enabling access by IPs, 10 CEPs 40 or other relevant people or entities. Social Networking applications may be featured to facilitate and increase participation in the EVG 20 system and method. Such social networking features may be accessed through any wireless, mobile, stationary, networking communication or internet enabled communication device, and include information access and delivery methods such as electronic messages, email, text messages, phone calls or messages, and through forum user accounts. Many functions may be performed by users of the EVG 20 system and method such as obtaining EV 30 status and other EVG 20 system updates; setting and tracking goals for EV 30 and reuse of RP; obtaining RP data and information such as natural resource usage; obtaining CEP 40 and IP 10 data and information such as location and participation commitment levels, organizing events and programs, publishing or posting information about RP and its reuse and about CEPs 40, playing games and participating in events and competitions, creating communities and groups of users, providing tools for IPs 10, communities and groups to monitor effects of their participation in the EVG 20; and providing tools to facilitate user engagement, effectiveness, and communication of events and information related to the EVG 20. Other information may be accessed through the EVG 20 system and method concerning natural resources, RPs and CEPs 40, including information about stores, organizations, entities, and other commercial product and service organizations regarding their products and services or their reuse of RP; information about and recognition for certain IP 10s 10 or groups of IPs 10 based on their reuse of RP and participation in the EVG 20; and other information about the IP 10 including their RP reuse acts and frequency, product or service purchasing, consumer choices, sales information associated with the RP or CEP, and market data about shopping trends, associated transactions, and consumer choices made by consumers while using the RP. Software compatible with the EVG 20 system and method and the communications and electronic devices and methods described herein, tie in the tracking, accessing, monitoring, and EV 30 generation methods and devices that make up the EVG 20.

The EVG's 20 processor uses the updated or real time RP use and reuse information of the individual participant IP 10 to update the associated data stored in a database when EVs 30 have been redeemed or otherwise depleted from an IP 10 account, and when CEPs 40 add EV 30 to an account or provide information relevant to the accounts. The EVG 20 and associated software connects the RP data to networks for CEP 40 and IP 10 usage, and allows access to the RP data by IP 10s and CEPs 40 through computer interfaces and social media applications. Other features may be available to users, such as comparison of historical RP information by that same individual or another individual in order to calculate the natural resource consumption reduction that results from acts of RP use or reuse taken by that individual. A processor similarly compiles multiple natural resource use reductions from a user or group of users to calculate the EV 30 resources that may be attributed to that person or group. A forum is provided for the users to market their generated EV 30 resources, where they may exchange the EV 30 resources for examples, for currency, for a credit to be used for reductions in their energy bill or other types of retail service or product transactions, for donation to a charitable organization, or to be exchanged directly with partner wholesale or retail organizations for their respective services or goods.

The EVG 20 enables individuals and groups of individuals, as well as CEPs 40 and the groups they form or are aggregated by association (Community Groups) to have: a) the knowledge and motivation to conserve natural resources, and b) the capability to market the natural resources conserved or reduced in the form of EV 30, an economic resource.

The EVG 20 provides new and enhanced forms of two-way communication from each IP 10 and CEP 40 such that benefits can be reliably attained by each. The EVG 20 takes advantage of the Internet, social media, associated networking and communication tools (web 2.0 applications and beyond such as Facebook, Twitter, etc.) and other communications means (email, phone, text messaging, etc.), to create a richer dialogue for the small-scale energy consumer. The EVG 20 is flexible and designed to take advantage of currently existing communications and tracking applications and means, and those to become available in the future.

### Behavioral Modification

The invention is a system and method that addresses the need to promote awareness of and facilitate natural resource conservation at the small-scale consumer level into a viable sized resource and to harness their EV 30 resources in a coordinated and reliable manner. The invention represents the integration of the appropriate behavioral science data into a tool that will successfully create valuable resources for individuals as well as commercial entities and other organizations that buy or sell consumer products. Behavioral studies clearly demonstrate that consumers that are educated and aware are most engaged in an issue requiring change from one's own behavioral predisposition and thus are best suited for positive and lasting behavioral changes.

The EVG 20 furthers the use of behavioral modification techniques mixed with modern tracking and communications methods. Group dynamics, including peer pressures, competition, team dynamics, and group contagion techniques, combined with tools comprising physical products and information to promote natural resource conservation and recycling are tied into a communications infrastructure in a pioneering way that will enable new learned behaviors to become a lasting part of individuals' lifestyles.

Applicant's EVG 20 utilizes technology as augmented by advanced behavioral modification techniques through mechanisms known to be successful at positively influencing individual behavior such as social communication, peer pressure and “culdesac-tivism” to generate a valuable and marketable resource in the form of EV 30 from small-scale natural resource conservation efforts. The acts of reuse of RPs by IP 10s as aggregated by the EVG 20 system and method by groups of people or community groups is a valuable resource that will be beneficial to the CEPs. EV 30 created through the EVG 20 can be exchanged for compensation to individual participants (IP), payments to groups they are participating on behalf of (e.g. a school or charitable organization) or some other usable consumer resource such as discounts, certificates or exchanges for product or service discounts with participating retail vendors.

Groups can be formed by individuals loosely or intimately involved in a small or large organization or entity, and may include neighborhood areas, geographical regions defined by governmental entities, associations such as churches, recreational clubs, schools, small businesses, etc. Larger communities seeking to promote natural resource conservation would also benefit. These include groups with goals of promoting natural resource consumption and waste reductions for their constituents, as well as county and state governments that have set associated long term waste and natural resource reduction goals.

The EVG 20 system and method may also be used for generating the data necessary to provide feedback to IPs 10 and CEPs 40 about theirs and others (peers) current and historical participation, natural resource consumptions, and other relevant information. The EVG 20 presents this consumption analysis to the IP 10 and CEP 40 in a manner that is both informative and encouraging. It also uses the analysis to bring IPs 10 and CEPs 40 together into groups such as “teams” for competitive or other motivational reasons to generate EV 30 resources. The EVG 20 administers the competition, and behavioral modification techniques may contribute to enhancing the potential effectiveness of natural resource consumption decrease compared with individual contributions to such decreases.

Education is another feature of the EVG 20 system and method, again useful for empowering the individual to take RP reuse and recycling actions in furtherance of creating EV 30 resources. Educational information about natural resource use and consumption provides people with more knowledge leading to motivation to make changes in their individual and business consumption practices. Communications alerts may inform IPs 10 of nearby CEPs 40 or other relevant information based on activities the IP 10 may be partaking or resources or information the IP 10 is seeking. The IP 10 and CEP 40 users may inform the EVG 20 system of these activities, resources and information at a certain time for the most optimized and updated or real time feedback, or the users may customize a profile with some general or specific information about them, or the IP 10 may choose from pre-set default profiles that may correspond with the user. The EVG 20, based on GPS information about an IP 10 or CEP 40, may suggest or recommend relevant information to the IP 10 or CEP 40 through social media applications, internet or other communications means. This feature educates the IP 10 and CEP 40 as to how their actions can create natural resource conservation and recycling improvements and add to the EV 30 being generated. The EVG 20 may also use historical data, regional data, and a database of natural resource saving methods to suggest future actions for the consumer to take to increase natural resource reduction. After a suggestion is made, the EVG 20 may analyze the effects on consumption and poll the consumer's opinions about the suggestion. This information will be used to help determine future suggestions.

Behavioral science impacts the way in which all aspects of the EVG 20 are presented to the IP 10 and CEP 40 user. It also determines the ways in which users are grouped together. Groupings have very strong effects on motivation, including peer pressure, competition, team effects, community involvement and much more. The EVG 20 system and method is flexible in that it can incorporate behavioral science techniques to optimize IP 10s impact on natural resource reduction, and is intended to effectively motivate people to reduce their natural resource consumption in both long term and short term ways.

This EVG 20 system and method is unique in bringing all these components together to operate in a coordinated manner to address individual, groups and business natural resource reduction. None of the prior art components to the EVG 20 addresses the creation of a valuable EV 30 resource that is marketable on a number of levels, including providing benefit to the consumer, the CEP 40, community groups and organizations, municipalities, and other entities in meeting waste reduction, natural resource reduction, recycling increase, economic, and/or greenhouse gas reduction goals. The EV 30 can be exchanged for compensation or credits, which can be used for retail or wholesale goods or services exchange. The EVG 20 can use real-time and historical data, behavioral modification techniques, group dynamics, modern communication and a forum for marketing the EV 30 created to create a complete tool for natural resource usage reduction. Updated or real-time data is fundamentally important because it closes the feedback loop which allows the IPs 10 to see their actual progress. Looking at historical analysis of that data of the individual users and others for comparison purposes also shows trends which also demonstrate progress and enables the measurement of the efforts of the users. Additionally, the historical data can be shared (anonymously or not) amongst consumers with similar characteristics to create behavioral responses that benefit natural resource and waste reduction efforts, including increases to recycling. This sharing of data is also key to the group dynamics of the system where the EVG 20 may use team effects and peer pressure to further motivate participants.

Information is presented to the IP 10 and CEP 40 user through a User Interface that has been designed around existing behavioral modification techniques and will incorporate new techniques as they develop. It is also the presentation tool for real-time and historical data and the management tool for the communications channels. Making use of effective, available communications means is the key to keeping the IP 10 and CEP 40 connected to the other components and features of the EVG 20, maximizing effectiveness of natural resource reduction.

Communications may be tailored to each IP 10 and CEP 40 based on their personal preferences, lifestyle factors and natural resource usage trends. Understanding the user's actual natural resource consumption habits including their use of consumer products is a part of the EVG 20 system's function. Users are asked to enter information about their personal habits and portfolio of appliances and other energy consuming devices. The level of detail can vary and can increase over time. Some information can be inferred when it is not available. A variety of user profiles and sub-profiles may be set and used by the EVG 20 for simplification, tailored for various individual and business types.

The relevant areas of modification and technology features, which are advantageously enhanced by the EVG 20, may include the application of behavioral modification techniques to better understand how people react and how they can be positively and effectively motivated with educational tools and other information specific to natural resource use, conservation and management. The EVG 20's processor uses comparison, calculation, compiling and analysis to determine the net natural resource reductions and data on EV 30 resources generated by users of the EVG 20. Other areas that facilitate effectiveness of the EVG 20 are communications and internet technology, tools and infrastructure. The innovative EVG 20 ties these features to enable a valuable marketable EV 30 resource.

Addressing natural resource conservation without addressing behavioral modification and educational aspects is not fully effective or sustainable and does not represent a complete solution to meeting consumption and population growth trends and environmental goals. Without sufficient education and awareness, people are susceptible to disengaging with the process. The EVG 20's function of creating a reliable verifiable and measurable resource by promoting small-scale acts of RP reuse and recycling, will facilitate the ability to track and forecast them as a viable, marketable and valuable economic resource.

### EXAMPLE 1

By way of example, a school desires to engage in a fundraiser program to raise additional funds for the school: The school administration and student groups select sustainability as the theme for their fundraiser and the school members begin selling reusable shopping bags and beverage holders (RP) in their communities. The school is divided into three grade levels, 6th, 7th and 8th. The school administration announces that each grade level is in competition with the others, and the grade level that sells the most amount of RP during the fundraiser program will receive the first set of updated computers (EV 30) for their grade level's use, and will have the privilege of seeing the other two grade levels perform a skit in the school auditorium in their honor. Each grade level is motivated to outsell the other grades, as the students and their parents would like to be assured of receiving new computer equipment (EV 30) and further, are encouraged by the thought of having other grade levels offer a performance to them (behavioral modification). The students and their parents are also motivated by an awareness that use of the RPs will reduce their individual environmental footprint, and desire being seen by other students and families as engaged in this campaign to be a better environmental steward.

After six weeks of selling RP in the school's fundraiser program, the results showed that the 7th graders sold the greatest amount of RP as determined on a per-student amount basis. The 7th graders were proud to be audience participants in a performance held four weeks later by the 6th and 8th grade classes. They were also quite pleased to have the first new computer show up in their classroom for use by the 7th grade students.

The students, families and neighbors who purchased RP through the school's fundraiser program receive instructions that if they used their RP when shopping at certain retail businesses, they would earn points (EV 30) toward rewards offered by those businesses. ‘Food-Land’ grocery store, and ‘Don't Be A Drip’ coffee shop (each a CEP) each have an EVG 20 system in their store to track use and reuse of RPs and offer an incentive to customers who make purchases using a reusable shopping bag and/or travel mug purchased through the school's fundraiser program. Food-Land and Don't Be A Drip offers these incentives through the EVG 20 system, recognizing the system's potential for attracting new customers to their stores who may have otherwise chosen to shop at other businesses, for reducing their business expenses for not having to purchase as many single use disposable products that were now being offset by customers' uses of their own RP, and desiring to be promoted as a sustainable business.

The Fundraiser Participants (IP) 10 were given a small card with a Quick Response (QR) code on one side with a unique identifier. The first time an IP 10 made a purchase with their RP and presented their QR card at the computer tablet display located at the checkout registers at both stores, the tablet prompted the IP 10 to register with identifying user name, email address or phone number data before or subsequent to the IP 10 scanning the QR code into the tablet. The IP's 10 identifying information and QR code data is then communicated to central databases when such information is stored, including the date, time and location of the store where that IP 10 used their RP to transport their purchase from that store. The IP 10 could instead simply input their unique indentifying information (user name, email address or phone number). Alternatively, Food-Land could have a static QR code available for scan by IP 10s who use RPs to transport purchased items from the store, that could be scanned by the IP 10 on their mobile phone having a QR code scanner application. Similarly, the data from the store's QR code and the IP's 10 unique mobile phone information, RP transaction data of time, location and RP or act is communicated to a central database where the RP usage transaction is stored.

A computer processor (EV generator) 30 assigns a point value to each IP's 10 RP usage transactions at Food-Land and Don't Be A Drip stores based upon points assigned for such use by the EVG 20 system. After the IP 10 reaches a threshold number of points, the stores offer a reward to the IP 10 that can be redeemed either at the store where the points were “earned” or at either store regardless of where the actual points were earned. With the knowledge that the IP 10 will eventually receive a reward for their actions taken to reduce their environmental impact by using their RP, the IP 10 is motivated to continue shopping at Food-Land and Don't Be A Drip over alternative stores in the same geographic area when they next need to make a purchase of that consumer category.

### EXAMPLE 2

By way of another example, an employer (CEP) 40 desires to reduce their company's environmental footprint and reduce operational costs by implementing processes that are more sustainable. Certain actions they have taken include requiring their external suppliers to use recyclable packaging in the products delivered to the company. Other actions include offering an employee sustainability incentive program to encourage employees to reduce costs and take healthier and more environmentally friendly actions pertaining to the workplace. The company installs an EVG 20 tracking system in places where the behavior they wish to modify occurs. For example, the company promotes that employees who engage in certain qualifying sustainable activities such as using alternative transportation, including riding the bus, carpooling with other employees, walking or riding a bicycle, (all RP) will receive points at a value set for the activity by the company for doing so. The employees who engage in qualifying alternative transportation track their daily activities by scanning their QR coded card by the EVG 20 system at the bike rack or front entry or by pressing in their id code (email or user name or ID #), or alternatively by making an appropriate entry on a website where they are logged in through unique identifying data to their own personal account. Other qualifying sustainable activities may also be recorded, such as using reusable mugs (RP) instead of single use disposable cups in the cafeteria or break room. Alternatively, each qualifying sustainable act may be recorded at a specified location using a mobile device and electronic identifier such as an RFID chip or QR code, e.g. at the front entrance or cafeteria, or may be self reported on the mobile device or computer. The unique identifier information and sustainable transaction data is communicated to a central database where points (EV) 30 are assigned to the qualifying sustainable acts. When an employee reaches a threshold number of points (EV) 30 ‘earned’ for making sustainable acts, the employer provides positive recognition of that employee within or external to the company and may even choose to offer an economic reward to him or her, such as a gift certificate to a local restaurant, offering a reusable product with the company logo on it, or offering a day of vacation.

1. A system for establishing an economic value for an activity involving reuse of material by a participant in conjunction with the interaction of that participant with one or more providers participating in one or more activities of the participant which results in the establishment of an economic value for that activity, comprising:
a participant interface configured to receive information from a participant regarding their status as a participant and to allow a participant to access information concerning their participation in an activity and the economic value associated therewith;
a provider interface configured to receive information from providers regarding their participation in one or more activities of one or more participants and enabling the provider to determine the status of their participation and the economic value thereof;
an electronic value generator capable of converting a participant activity with an economic value assigned to that use by a provider; and
a storage capable of correlating the activity of a participant with a total economic value for the activities of the participant.

2. The system for establishing an economic value of claim 1, wherein the activity involving reuse further includes an activity designated by a provider.

3. The system for establishing an economic value of claim 2, wherein the activity includes at least one of carpooling and the use of public transportation.

4. The system for establishing an economic value of claim 1, wherein the economic value is based upon points.

5. The system of claim 4, wherein said points are assigned by the provider.

6. The system of claim 1, wherein said economic value is redeemable for a value.

7. The system of claim 6, wherein said economic value is redeemable for value at a provider.

8. The system of claim 6, wherein said economic value is redeemable for value at a provider other than the provider from which at least a portion of the points underlying the economic value were received.

9. The system of claim 1, wherein said economic value may be assigned by a participant to a third party.

10. The system of claim 1, wherein the participant is a collection of individuals.

11. A method of establishing an economic value for an activity involving reuse of material by an individual in conjunction with the interaction of that individual participant with one or more providers participating in one or more activities of the participant which results in the establishment of an economic value for that activity, comprising:
receiving information from an individual regarding their status as a participant and allowing a participant to access information concerning their participation in an activity and the economic value associated therewith;
receiving information from one or more providers regarding their participation in one or more activities of one or more participants and enabling the provider to determine the status of their participation and the economic value thereof;
generating an economic value based upon a participant activity with an economic value assigned to that use by a provider; and
providing a storage capable of correlating the activity of a participant with a total economic value for the activities of the participant.

12. The method of claim 11, wherein the step of receiving information from a provider includes receiving a point value associated with an activity.

13. The method of claim 11, wherein the step of receiving information from a provider includes receiving information from a provider regarding the provider's participation in the redemption of economic value.

14. The method of claim 11, wherein the step of generating an economic value includes the step of converting a point value assigned to the activity by a provider into an economic value based upon the current and prior participant receipt of points from that provider.

15. The method of claim 11, wherein the step of generating an economic value includes the step of converting a point value assigned to the activity by a provider into an economic value based upon the current and prior participant receipt of points from all providers.

16. A method of generating an economic value through the use and reuse of a reusable product (RP) during a consumer transaction or social activity, the method comprising:
tracking information about one or more transactions or activities that occur associated with the RP,
generating an economic value (EV) from the information tracked,
providing an interface for accessing the EV,
identifying a network of participants from which some or all of the EV may be redeemed or exchanged in commerce.

17. A system for generating an economic resource from acts of reuse of a product (RP) in commerce by individual participants (IP) or groups of IPs, comprising:
a tracking portion for tracking information about one or more transactions that occurs associated with the RP,
an economic value generator that generates an economic value (EV) from the information tracked by the tracking portion,
a redeeming portion for enabling an IP or group of IPs to redeem or exchange the EV generated for at least one of a) currency, b) discounts or c) exchanges toward products or services offered in commerce,
a compiling device for maintaining and updating the EV corresponding to an IP or group of IP's based on the respective EV generated and redeemed; wherein said tracking portion, said EV generator, said redeeming portion, and said compiling device are provided by one or more processors.
